(19) United States
(12) Patent Application Publication
(10) Pub. No.: US 2006/0184439 A1
(43) Pub. Date: Aug. 17, 2006

(54) Asset backed commercial paper program

(76) Inventor: Hans Bald, New York, NY (US)

Correspondence Address: CLIFFORD CHANCE US LLP, 31 WEST 52ND STREET, NEW YORK, NY, 10019-6131, US

(21) Appl. No.: 11/323,967

(22) Filed: Dec. 29, 2005

Related U.S. Application Data
(60) Provisional application No. 60/640,955, filed on Dec. 30, 2004.
(60) Provisional application No. 60/640,941, filed on Dec. 30, 2004.

(51) Int. Cl. G06Q 40/00

(52) U.S. Cl. 705/35

(57) ABSTRACT

In general, in one aspect, the invention includes an asset backed securities structure. The structure includes a first and second liquidity and/or credit provider and an entity structured to acquire interest in financial assets from sellers (and to issue to a plurality of investors notes backed by the financial assets). The structure also includes a liquidity and/or credit agreement between the entity and the liquidity and/or credit providers. The agreement provides that when funding is required, the first (i.e., subordinate) liquidity and/or credit provider contributes an amount up to a predetermined commitment level and the second (i.e., senior) liquidity and/or credit provider contributes an additional amount only if the amount contributed by the first liquidity and/or credit provider is less than the required funding amount. Contributions by the liquidity and/or credit provider may be realized by a purchase of an interest in the financial assets acquired by the Company from the sellers. In some implementations, the agreement is also structured such that upon a repayment to the liquidity and/or credit providers, the second provider receives payments in an amount sufficient to repay the amount contributed by the second provider and, only if sufficient repayment funds exist, the first provider receives repayment up to a lesser of the amount of funds available or an amount contributed by the first provider. In general, in another aspect, the invention includes a method of issuing asset backed securities by an issuing entity. The method includes (i) acquiring interests in financial assets of sellers; (ii) issuing to investors Notes where the acquired interest in the financial assets back the issued Notes; (iii) paying interest on the Notes to the investors; and (iv) when additional liquidity is required, drawing funds from liquidity and/or credit providers. Drawing funds includes drawing from a first liquidity and/or credit provider up to a maximum amount of a commitment by that liquidity and/or credit provider and then drawing from an additional liquidity and/or credit provider only after the maximum amount of the commitment by the first liquidity and/or credit provider has been drawn.

### CROSS REFERENCE TO RELATED APPLICATIONS

This application claims the benefit of U.S. Provisional Application No. 60/640,941, filed Dec. 30, 2004, and of U.S. Provisional Application No. 60/640,955, filed on Dec. 30, 2004.

### SUMMARY OF THE INVENTION

In general, in one aspect, the invention includes a novel structure for an asset backed commercial paper (“ABCP”) program. The structure allows for shifting of certain risks between program participants (e.g., the structure allows for shifting of certain risks among credit and liquidity providers). The general structure of the entities involved and of the commercial paper issued pursuant to the program is shown in the figure on page 5 and described herein.

The ABCP program includes a special purpose corporation (the “Company”) which acquires interests in financial assets of certain entities (“Sellers”) and issues commercial paper (“CP” or the “Notes”) to investors; the financial assets acquired from the Sellers back the issued Notes. Generally speaking, the program is structured so that the financial assets acquired by the Company will provide a return that is in excess of the return on the Notes.

In structuring an ABCP program, a program sponsor must account for certain risks inherent in a program. These include a risk of default with respect to the financial assets (“credit risk”) as well as a risk of not being able to re-issue Notes upon their Maturity (“liquidity risk”). To compensate for credit risk and liquidity risk, the program sponsor can provide for credit enhancement and/or a back-up liquidity facility. Generally speaking, credit enhancement may be (i) pool specific or (ii) program wide. The pool-specific arrangement covers losses or liquidity risk associated with a specific named part of the asset pool (e.g., on assets contributed by a specific seller), while program-wide enhancement is a layer of credit protection that can be drawn on to cover losses or liquidity risk if the pool-specific facilities have been used up.

In addition to credit enhancement, other liquidity support may be provided. Generally speaking, in an ABCP program, liquidity providers, such as commercial banks, make funds available that can be used for reasons other than losses due to asset default. For example, a liquidity line may be drawn on to ensure timely repayment of maturing Notes in the event that new Notes cannot be issued. The availability of a liquidity arrangement assures investors that CP will be repaid in full on its maturity date.

Liquidity facilities and credit enhancement facilities may take various forms. The ABCP program described herein primarily makes use of asset purchase agreements. Under such an arrangement, the provider of a facility purchases assets from the Company at a pre-determined price that is equal to the amount of Notes issued by the Company to purchase the asset along with an amount sufficient to pay interest on the Notes.

While the assurance of sufficient liquidity and credit enhancement is essential to attracting investors (and to maintaining a desired investment rating), it can be difficult to attract parties other than the program sponsor who are willing to take on the risks associated with providing liquidity and/or credit enhancement, especially at fees that make it economically feasible for the program sponsor. To mitigate such issues, the ABCP program described herein includes a risk shifting feature which, due to the shift of certain risks to, for example, the program sponsor, will reduce the cost of obtaining a liquidity facility or credit enhancement facility from a third party and may reduce the extent to which third parties need to do due diligence on the underlying assets. To provide for such risk shifting, the ABCP program disclosed herein can include a tiered structure in which certain liquidity and/or credit enhancement providers are not drawn upon until other liquidity/credit enhancement providers (e.g., the program sponsor) have been drawn upon to the extent of a previously established commitment level. Thus, “subordinate” liquidity/credit providers (i.e., those which assume a higher level of risk such as the program sponsor) are drawn upon before the “senior” providers. In one implementation, the “subordinate” liquidity provider is the program sponsor and the senior providers are not drawn upon until after the program sponsor has been drawn upon to the extent of the sponsor's commitment. The structure can also be used in a program where assets are contributed by the program sponsor or other party, with that party having first exposure for losses related to those assets. Thus, where the program sponsor or other party seeks to contribute assets that may be less desirable (e.g., because they have a lower credit rating), any risk associated with those assets will be borne by the contributing Seller.

Risk shifting may also be based on a prioritization of repayment. The mechanics of this program anticipate a repayment based on a tiered structure in which participants assuming a lower level of risk receive repayment before those assuming higher levels of risk. In this case, the “subordinate” liquidity providers (e.g., the program sponsor) receive repayment only after amounts owed to “senior” providers have been satisfied.

Implementations of the disclosed ABCP program structure may include advantages such as allowing a party structuring the ABCP program to attract additional partners by shifting risks away from those additional partners.

### BRIEF DESCRIPTION OF THE FIGURES

FIG. 1 is a diagram of the structure supporting the method of the invention.

### DETAILED DESCRIPTION OF THE INVENTION

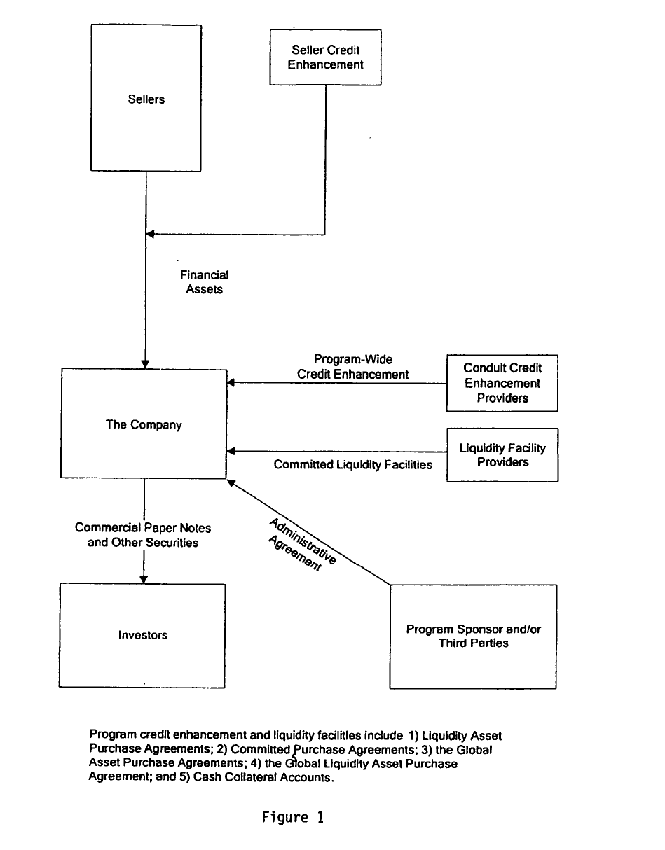

FIG. 1 discloses participants in a typical ABCP program structure. Example duties and obligations of the participants are described in detail herein. Also described are credit and liquidity arrangements which can provide for risk shifting to, e.g., the program sponsor, and away from other participants. It should be understood that the example duties and obligations described herein are not necessary in all programs and commercial paper structured in accordance with the invention. For example, implementations may alter particular commitments under the GAPA and GLAPA agreements described herein or may otherwise provide for liquidity and risk shifting among liquidity providers. Although described with respect to asset backed commercial paper, implementations may also apply the invention to other pooled financial assets.

The Company

The ABCP program described herein can be administered by a special purpose corporation referred to herein as the Company. The Company may be an orphan subsidiary established by the ABCP program sponsor and may hire the program sponsor as its administrator and to conduct its day to day activities. Generally speaking, the Company is the entity that provides access to the commercial paper market by providing Sellers with a means of financing their Financial Assets. These Sellers obtain this financing by selling interests in some or all of their Financial Assets to the Company at a price expected to provide a return to the Company sufficient to pay the Notes, ECP Notes or Other Notes issued to fund the Company's acquisition of such interests in Financial Assets. Sellers also may borrow from the Company and may secure such borrowing by pledging Financial Assets sufficient to pay the Notes, ECP Notes or Other Notes issued to fund such borrowing. The Company will generally receive fees and interest payments from a Seller which shall exceed amounts needed for the payment of all transaction costs and interest expenses incurred by the Company in connection with the issuance of the Notes, ECP Notes or Other Notes related to such Seller's financing facility with the Company.

The Company may be structured as a special purpose corporation which (a) purchases, makes loans secured by and otherwise acquires interests (including both ownership and security interests) in, or undivided interests in, pools of, accounts, general intangibles, chattel paper, instruments, certificated and uncertificated securities, investment property, or other financial assets, including, without limitation, publicly or privately issued securities, which may be secured by or represent interests in any of the foregoing or be unsecured debt, equity securities, commercial paper and credit-linked notes (“Financial Assets”) of certain entities (“Sellers”), (b) sells or otherwise disposes of interests in Financial Assets and (c) engages in other activities incidental to the foregoing.

The Company generally obtains the funds used to make such purchases and acquisitions or find such loans by issuing commercial paper notes in the United States domestic commercial paper market (the “Notes”) and/or in other currencies and markets, such as in the European commercial paper market (the “ECP Notes”). The Company may also issue medium term notes, callable notes, extendible notes and other securities (collectively, “Other Notes”). Generally speaking, each purchase of interests in, and each loan secured by, Financial Assets is expected to provide a return (“Yield”) in excess of the interest applicable to the Notes, ECP Notes or Other Notes issued by the Company to finance such purchase or loan. In some implementations, the Company may enter into hedge agreements to reduce risks associated with interest rate or currency fluctuations.

The Notes

Generally speaking, the Notes are the CP purchased by investors and which provide for interest or other return to the investors. The Notes may be secured or unsecured obligations of the Company and will typically have short-term maturities (e.g., generally up to 270 days from the date of issuance). The Notes may be sold on either a discount basis or an interest-bearing basis. Further, Notes sold on an interest-bearing basis may be index-linked Notes. In some implementations, the interest rate and the amount of interest to accrue to maturity on index-linked Notes is not fixed on the date of issuance; instead one or both may be linked to a relevant underlying index and will fluctuate with changes in that underlying index.

Interest on the Notes is generally expected to be paid from the Yield on the Financial Assets. In most cases, funds for repayment of the principal portion of the Notes will be obtained by issuing new Notes (“Replacement Notes”). In other cases (for example, if the Company ceases for any reason to acquire Financial Assets from a particular Seller), the funds will be obtained from collections on the Financial Assets (the “Collections”). The Company also may obtain funds for the repayment of Notes under the Liquidity and Credit Facilities and Conduit Credit Support (each as described hereinafter). Generally speaking, the Company will not acquire, or make loans secured by, Financial Assets unless, at the time of acquisition or at the time the loan is made, as applicable, Collections from such Financial Assets are expected to be sufficient to make all required payments on the Notes.

It is expected that funds for repayment of the Notes at maturity will be obtained either from the issuance of additional Notes or from Collections of the related Financial Assets and if those sources are insufficient to pay maturing Notes, from advances under the Program Facility, or the purchase price of interests in the Financial Assets sold under the related Liquidity Asset Purchase Agreement or Committed Purchase Agreement, or the GAPA or GLAPA, if applicable, or amounts available under the Seller Credit Enhancement or Conduit Credit Support. Nevertheless, if the Financial Assets include substantial amounts of defaulted Financial Assets, the amounts available may be less than the amount needed to repay related maturing Notes. The proceeds of Note issuances (net of discount, fees and commissions) will be applied first to pay maturing Notes and then to acquire interests in Financial Assets, or to make loans secured by Financial Assets, pursuant to any Financial Asset Agreement.

At the time Financial Assets are acquired by or pledged to the Company, Collections from such Financial Assets are expected to be sufficient in amount to permit repayment of all principal and payment of interest on the Notes issued to fund the acquisition of such Financial Assets or the loans secured by such Financial Assets. Nevertheless, timing differences between the receipt of Collections and payments on the Notes may require draws under the Liquidity and Credit Facilities or the Conduit Credit Support if commercial paper funding is not available. In addition, to provide protection for the Company against losses related to defaults by the related Seller, the Company can, in certain cases, obtain funds under the GAPA, GLAPA Seller Credit Enhancement, the Conduit Credit Support and/or any Transaction Specific Reserves.

The Company may issue the Notes under an arrangement with a party acting as issuing and payment agent and depositary with respect to the Notes (in such capacity, the “Depositary”). The face amount of each Note and, in the case of interest bearing Notes, accrued and unpaid interest thereon will be paid upon maturity, or as otherwise indicated by the Administrative Agent, in immediately available funds, to the extent available, upon presentation of the Notes at the office of the Depositary. If such funds are insufficient to pay such Notes in full, the Depositary will notify the Company and the Administrative Agent, and the Administrative Agent will request the relevant party under the relevant Liquidity and Credit Facilities to make purchases or advances, as applicable, thereunder and/or draw funds under the Conduit Credit Support and transfer the funds received to the Depositary. If an insufficiency still exists, the Depositary will pay all Notes pro rata to the extent of available funds.

Liquidity and Credit Facilities

The Notes are, and the ECP Notes and the Other Notes are, supported by the Liquidity and Credit Facilities and the Conduit Credit Support. If the Company does not have the funds necessary to repay the principal amount of and/or pay the accrued interest on the Notes, ECP Notes or Other Notes (from Replacement Notes or Collections), such repayment or payment may be funded through access to funds available (a) under Seller Credit Enhancement, Liquidity Asset Purchase Agreements, Committed Purchase Agreements, the GAPA, the GLAPA or the Program Facility, in each case, as defined hereinafter (collectively, the “Liquidity and Credit Facilities”) or (b) under the Conduit Credit Support described below.

In order to provide liquidity support for the Notes, the ECP Notes and the Other Notes, (a) one or more Purchasers and the Company will enter into Liquidity Asset Purchase Agreements (in general, such agreements are used when the Administrative Agent prefers that a liquidity facility be provided with respect to specific Sellers) whereby the Purchasers will be obligated to purchase interests in certain Financial Assets or make loans secured by certain Financial Assets and/or (b) one or more banks or financial institutions (in such capacity, the “Committed Purchasers”) may enter into Committed Purchase Agreements whereby the Committed Purchasers will purchase certain Financial Assets and/or (c) the Company and the GAPA Purchaser will enter into a GAPA Confirmation whereby the GAPA Purchaser will commit to purchase, at the Company's option, either a participation interest in or the Company's entire ownership interest in certain Financial Assets and/or (d) the Company and the GLAPA Purchasers will enter into a GLAPA Confirmation whereby the GLAPA Purchasers will commit to purchase, at the Company's option, either a participation interest in or the Company's entire ownership interest in certain Financial Assets. In addition, the Company may require a Seller to arrange for Seller Credit

Enhancement to provide liquidity and credit support for the Notes issued to fund the acquisition of, or loan secured by, such Seller's Financial Assets.

Pursuant to each Liquidity Asset Purchase Agreement, if on any date the Company does not have sufficient funds to pay maturing Notes, the relevant Purchasers will be obligated, subject to agreed upon limitations, to purchase from the Company interests in the relevant Financial Assets previously acquired by the Company. The Company will use the proceeds from such sales to make required payments on such Notes. The aggregate purchase prices of such sales pursuant to each Liquidity Asset Purchase Agreement at any time shall not exceed the lesser of (a) the available commitment thereunder, (b) if applicable, the sum of the aggregate outstanding amounts advanced to the Seller by the Company pursuant to the related Seller Agreement plus, in certain cases, an amount intended to cover accrued Yield thereon and (c) a formula amount based on the amount of relevant non-defaulted Financial Assets. Subsequent Collections on the Financial Assets sold to Purchasers under the Liquidity Asset Purchase Agreement will no longer be available to the Company.

Preferably, the Company will not issue Notes, ECP Notes or Other Notes with respect to a particular Seller if such issuance would cause the aggregate face amount of the outstanding Notes, ECP Notes or Other Notes issued to fund the Company's acquisition of, or loans secured by, Financial Assets related to such Seller (other than Financial Assets consisting of certain qualifying commercial paper of such Seller) plus the principal amount of outstanding Short-term Advances (as defined hereinafter) the proceeds of which have been applied to repay such Notes, ECP Notes or Other Notes to exceed the unused portion of the amounts available for the repayment of such Notes, ECP Notes or Other Notes under a Liquidity Asset Purchase Agreement, Seller Credit Enhancement, the GAPA, the GLAPA and/or a Committed Purchase Agreement.

Seller Credit Enhancement

Seller Credit Enhancement may take the form of a seller-specific letter of credit, guaranty or other similar instrument. Drawings may be made against the Seller Credit Enhancement if there have been defaults on Financial Assets. The aggregate amount of Seller Credit Enhancement, if any, with respect to any Financial Assets will vary based upon determinations by the Administrative Agent on a case-by-case basis.

GAPA and GLAPA Agreements

The Company may enter into an agreement known herein as the Global Asset Purchase Agreement (the “GAPA”) with a “GAPA Purchaser” (in one implementation, the GAPA Purchaser may be the same entity as, e.g., the Administrative Agent). Upon the occurrence of certain events, the GAPA Purchaser will purchase from the Company either a participation interest in, or the Company's entire interest in, the Financial Assets of a particular Seller for which the GAPA Purchaser has delivered a confirmation in a form specified under the GAPA (each, a “GAPA Confirmation”). The GAPA Purchaser's obligation to make a purchase may be subject to the condition that the Company not be the subject of a bankruptcy or similar proceeding at such time. In addition, the GAPA Purchaser may make liquidity advances (“GAPA Liquidity Advances”) available to the Company to repay maturing Notes, ECP Notes, Other Notes or Short-term Advances. The proceeds from any purchase under the GAPA will be used first to repay GAPA Liquidity Advances, second to pay Notes, ECP Notes or Other Notes maturing on the date of such purchase and third to pay Short-term Advances.

The Company may also enter into a Global Liquidity Asset Purchase Agreement (the “GLAPA”) with liquidity providers who, preferably, are rated at least as high as the then current rating of the Notes (the “GLAPA Purchasers”). Pursuant to the GLAPA, the GLAPA Purchasers commit to purchase, at the Company's option, either a participation interest in or the Company's entire ownership interest in the Financial Assets of each particular Seller for which the GLAPA Purchasers have delivered a confirmation in one of two forms specified under the Global Liquidity Asset Purchase Agreement (each, a “GLAPA Confirmation”)

In accordance with the invention, risk is shifted among GLAPA Purchasers by structuring GLAPA Purchasers or financial institutions into different tiers where the obligation to make a purchase under a GLAPA Confirmation is subject to the condition that all lower-tiered (subordinate) parties have first been drawn upon to the full extent of their commitment under the GLAPA. In one embodiment, there may be two “tiers” including a lower tier (i.e., a subordinate tier which may include, e.g., the program sponsor) and an upper tier (i.e., a senior tier which may include, e.g., other banks or financial institutions). In this implementation, the GLAPA Purchasers' obligations to make a purchase under a GLAPA Confirmation providing for a liquidity commitment (each, a “Liquidity Confirmation”) will be in accordance with this tiered structure and subject to (a) the condition that the Company not be the subject of a bankruptcy or similar proceeding at such time, (b) a purchase price formula designed to assure that the interests purchased by the GLAPA Purchasers are fully supported by non-defaulted Financial Assets and (c) in the case of GLAPA Purchasers other than the subordinate tier GLAPA Purchaser, the condition that the subordinate tier GLAPA Purchaser shall have first been drawn upon to the full extent of its commitment under the GLAPA. The GLAPA Purchasers' obligations to make a purchase under a GLAPA Confirmation providing for a credit enhancement commitment (an “Enhancement Confirmation”) will be subject to (a) the condition that the Company not be the subject of a bankruptcy or similar proceeding at such time and (b) in the case of GLAPA Purchasers other than the subordinate tier GLAPA Purchaser, the condition that the lower tier GLAPA Purchaser (e.g., the program sponsor) shall have first been drawn upon to the full extent of its commitment under the GLAPA.

Risk may also be shifted among GLAPA purchasers based upon a prioritization of repayment of the purchase price of an asset. In one implementation, the lower tiered purchasers (i.e., the subordinate purchasers) will not be repaid until more senior tiered purchasers have received payments from assets purchased by the lower tiered purchaser and the more senior purchasers in an amount sufficient to repay the entire amount advanced by the senior purchasers. For example, in one implementation, where a subordinate and senior purchaser have each provided liquidity in relation to a specific pool of assets, any collections obtained by the Company on those assets will first be provided to the senior purchaser until it has received an amount sufficient to repay the entire amount that it has advanced before any collections will be paid to the subordinate purchaser. In another implementation, where a subordinate and senior purchaser have each provided for credit enhancement and each has provided for such credit enhancement in relationship to their own specific pool of defaulted assets, any collections obtained by the Company on those defaulted assets will first be provided to the senior purchaser regardless of whether or not the collections were from defaulted assets associated with the senior purchaser or from defaulted assets associated with the subordinate purchaser.

The condition that subordinate GLAPA Purchaser(s) shall have first been drawn upon to the full extent of its or their commitment and repaid subsequent to third party (i.e., the senior) providers under the GLAPA provides for an improved business structure providing for a shifting of initial risk to the subordinate GLAPA Purchaser(s) and away from other liquidity and/or credit providers (i.e., the senior providers). This risk shifting may improve the ability to attract liquidity providers for the ABCP program. For example, where the subordinate purchaser is the program sponsor, it may be easier to attract third parties to participate in the program by involving them as senior parties drawn upon only after the program sponsor and/or repaid prior to the program sponsor.

Generally speaking, this liquidity/credit enhancement structure differs from previous asset backed commercial paper structures wherein the liquidity/credit enhancement providers were drawn upon on a pro-rata basis and, thus, all participants had to bear program risks on a pro-rata basis upon a default or other realization of risks. Here, participants other than the lower-tiered GLAPA Purchasers bear risk only if defaults or other realizations of risks exceed the full commitment of those lower-tiered participants. Implementations of the invention may also use other tiered structures. For example, once the full extent of the first tier GLAPA Purchaser commitment has been reached, one or more additional tiers of liquidity providers may be drawn upon in sequence to the full extent of each tier's commitment. If a tier consists of multiple parties, the parties within a tier can be drawn upon on a pro-rata basis to the full extent of that tier's commitment and then the remaining tiers of liquidity providers may be drawn upon on a pro-rata or other agreed-upon basis.

The Company may also enter into committed purchase agreements (each, a “Committed Purchase Agreement”) in connection with its acquisition of certain Financial Assets, particularly trust certificates and asset-backed securities, pursuant to which the committed purchaser will purchase from the Company either a participation interest in or the Company's entire interest in such Financial Assets. Such commitment will eliminate or reduce the amount of liquidity necessary under a Liquidity Asset Purchase Agreement, the GAPA or the GLAPA. The Company may also enter into an Amended and Restated Credit and Liquidity Facility (the “Program Facility”) with one or more “Credit Providers” to provide additional liquidity support for the Notes.

Program Facility

To provide additional flexibility to the Company, a “Committed Lender” and the Company entered into the Program Facility. The Program Facility provides support for a portion of the commitment of parties obligated to make purchases or advance loans under the Liquidity Asset Purchase Agreements and the Committed Purchase Agreements who are rated less than the rating then applicable to the Notes based upon a methodology approved by a rating agency such as Moody's Investors Service, Inc. (“Moody's”), Standard & Poor's, a Division of The McGraw-Hill Companies, Inc. (“S&P”) and Fitch, Inc. (the “Rating Agencies”). In the event any such party defaults on its obligations, a “Committed Lender” will be obligated, subject to a maximum amount based upon the aforementioned methodology, to make advances (“Committed Advances”) to the Company in an amount equal to the amount that the defaulting party was obligated to advance under the related Liquidity Asset Purchase Agreement or the Committed Purchase Agreement, as the case may be. The Committed Lender may also provide short-term advances (“Short-term Advances”). The Short-Term Advances will be available to repay maturing Notes, ECP Notes and Other Notes, other Short-term Advances and amounts payable under certain hedge agreements.

A cash collateral account (“Conduit Credit Support”) may also be established. Amounts drawn under the cash collateral account may be applied to the payment of Notes or Short-term advances maturing on the date of such draw. In some implementations, letters of credit may be provided instead of or in addition to using cash collateral accounts.

Transaction Specific Reserves

Transaction Specific Reserves will be in place for certain Financial Asset Agreements. When used, Transaction Specific Reserves generally will take the form of overcollateralization, but may take the form of Seller Credit Enhancement, a cash collateral account or recourse to the related Seller. Transaction Specific Reserves are designed to protect the Company against losses in the event a portion of the Financial Assets are not paid in full by the related Sellers.

Administrative Agent

The Administrative Agent (which may be, e.g., the program sponsor) provides services in connection with the structuring, negotiation and acquisition of the Company's interests in Financial Assets, the administration and monitoring of such Financial Assets, the Liquidity and Credit Facilities, the Conduit Credit Support and the issuance, sale and payment of the Notes, ECP Notes and Other Notes. The Administrative Agent may also perform due diligence with respect to each Seller. More specifically, the Administrative Agent may (a) evaluate the historical performance of Sellers'Financial Assets and (b) when the Administrative Agent deems it appropriate based on the particular Financial Assets involved, recommends levels and forms of overcollateralization or other transaction specific reserves.

Other Banks

After consultation with the Administrative Agent, other banks or financial institutions may be selected to participate in the Liquidity and Credit Facilities. In order to maintain the ratings of the Notes, participating banks generally must have a short-term rating at least equivalent to that assigned to the Notes by the Rating Agencies then rating the Notes at the Company's request (or otherwise be acceptable to such Rating Agencies). If any participant in the Liquidity and Credit Facility fails to have or maintain such a rating, at the option of the Administrative Agent, that participant's commitment under the Liquidity and Credit Facilities will be (a) supported, to the extent described below, by Committed Advances under the Program Facility, (b) assigned to another acceptable bank or financial institution or (c) if provided for under applicable documentation, drawn by the Company and deposited in a cash collateral account in the Company's name until the cash is used to make payments on the Notes.

A number of embodiments of the present invention have been described. Nevertheless, it will be understood that various modifications may be made without departing from the spirit and scope of the invention. Accordingly, other embodiments are within the scope of the invention.

1. A method for offering asset backed securities to investors comprising:
(i) forming an issuing company capable of acquiring interests in the financial assets of at least one seller;
(ii) forming a predetermined agreement among a plurality of providers for creating an obligation, whereby each of the providers commits to a predetermined level of funding that may be accessed by the company, and whereby the entire obligation will be shared among the plurality of providers;
(iii) issuing at least one note by said company to at least one investor, wherein said note has a maturity date, and wherein the acquired interests in the financial assets back the issued note, whereby, if the acquired interests in the financial assets do not produce sufficient funds to pay the note in full on the maturity date, then the providers will be drawn upon by the company to cover the insufficiency.

2. The method of claim 1, wherein said obligation is from conduit credit enhancement providers.

3. The method of claim 1, wherein said obligation is from liquidity facility providers.

4. A method for offering asset backed securities to investors comprising:
(i) forming an issuing company capable of acquiring interests in the financial assets of at least one seller;
(ii) forming a first predetermined agreement between the company and a first set of one or more providers for creating an obligation, whereby each of the providers commits to a predetermined level of funding that may be accessed by the company, and whereby the entire obligation will be shared among said first set;
(iii) forming a second predetermined agreement between the company and a second set of one or more providers for creating an obligation, whereby each of the providers commits to a predetermined level of funding that may be accessed by the company, and whereby the entire obligation will be shared among said second set; and
(iv) issuing at least one note by said company to at least one investor, wherein said note has a maturity date, and wherein the acquired interests in the financial assets back the issued note, whereby, if the acquired interests in the financial asset do not produce sufficient funds to pay the notes in full on the maturity date, then said first set will exhaust its obligation in whole or in part prior to access to said second set.

5. The method of claim 4, wherein said obligation is from conduit credit enhancement provider(s).

6. The method of claim 4, wherein said obligation is from liquidity facility provider(s).

7. A method for offering asset backed securities to investors comprising:
(i) forming an issuing company capable of acquiring interests in the financial assets of at least one seller;
(ii) forming a first predetermined agreement between the company and a first set of one or more providers for creating an obligation, whereby each of the providers commits to a predetermined level of funding that may by accessed be the company, and whereby the entire obligation will be shared among said first set;
(iii) forming a second predetermined agreement between the company and a second set of one or more providers for creating an obligation, whereby each of the providers commits to a predetermined level of funding that may be accessed by the company, and whereby the entire obligation will be shared among said second set;
(iv) issuing at least one note by said company to at least one investor, wherein said note has a maturity date, and wherein the acquired interests in the financial assets back the issued note, whereby, if the acquired interests in the financial asset do not produce sufficient funds to pay the notes in full on the maturity date, then said first set will exhaust its obligation in whole or in part prior to access to said second set; and
(v) wherein said company establishes that if the company draws the obligation from said first set and from said second set, the company will pay said second set first in an amount sufficient to repay the funds contributed by said second set and, only if sufficient repayment funds remain, said first set receives repayment up to a lesser of the amount of funds available or the amount contributed by said first set.

8. The method of claim 7, wherein said obligation is from conduit credit enhancement provider(s).

9. The method of claim 7, wherein said obligation is from liquidity facility provider(s).

10. A method for offering asset backed securities to investors comprising:
(i) forming an issuing company capable of acquiring interests in the financial assets of at least one seller;
(ii) forming a first predetermined agreement between the company and a first set of one or more providers for creating an obligation, whereby each of the providers commits to a predetermined level of funding that may be accessed by the company, and whereby the entire obligation will be shared among said first set;
(iii) forming a second predetermined agreement between the company and a second set of one or more providers for creating an obligation, whereby each of the providers commits to a predetermined level of funding that may be accessed by the company, and whereby the entire obligation will be shared among said second set;
(iv) issuing at least one note by said company to at least one investor, wherein said note has a maturity date, and wherein the acquired interests in the financial assets back the issued note, whereby, if the acquired interests in the financial asset do not produce sufficient funds to pay the notes in full on the maturity date, then said first set and said second set will exhaust their obligations in whole or in part on a pro-rata basis; and
(v) wherein said company establishes that if the company draws the obligation from said first set and from said second set, the company will pay said second set first in an amount sufficient to repay the funds contributed by said second set and, only if sufficient repayment funds remain, said first set receives repayment up to a lesser of the amount of funds available or the amount contributed by said first set.

11. The method of claim 10, wherein said obligation is from conduit credit enhancement provider(s).

12. The method of claim 10, wherein said obligation is from liquidity facility provider(s).

13. A financial product resulting from implementation of the method of claim 1.

14. A financial product resulting from implementation of the method of claim 4.

15. A financial product resulting from implementation of the method of claim 7.

16. A financial product resulting from implementation of the method of claim 10.
